(19) United States
(12) Patent Application Publication
(10) Pub. No.: US 2022/0393401 A1
(43) Pub. Date: Dec. 8, 2022

(54) STRETCHING STRAP UNLOCK CONNECTOR

(71) Applicant: JESS-LINK PRODUCTS CO., LTD., New Taipei City (TW)

(72) Inventors: CHING-HUNG LIU, New Taipei City (TW); CHI-HSIEN SUN, New Taipei City (TW)

(21) Appl. No.: 17/749,727

(22) Filed: May 20, 2022

(30) Foreign Application Priority Data
Jun. 3, 2021 (TW) 110206433

(51) Int. Cl. H01R 13/633; H01R 13/627

(52) U.S. Cl. CPC H01R 13/6335; H01R 13/6272

(57) ABSTRACT

A stretching strap unlock connector includes a socket and a plug. The socket includes a socket case including a fixing latch, and the fixing latch has a fixing hole. The plug includes a plug case, a strap and an upper cover. The plug case includes a fixing component configured to buckle the fixing hole and has a unlock groove and a fixing groove. The strap is moveably configured on the plug case and includes a unlock structure configured in the unlock groove. The upper cover includes an engaged structure buckled in the fixing groove. When the strap is pulled, the unlock structure is detached from the unlock groove for lifting the fixing latch to detach the fixing component from the fixing hole, and the engaged structure ensures that the upper cover not be detached from the plug case.

### BACKGROUND OF THE INVENTION

### 1. Field of the Invention

The present invention relates to an electrical connector, and more particularly, to a stretching strap unlock connector that can improve practicability and efficiency.

### 2. Description of the Prior Art

Connectors are connecting components and accessories for electrical signals, and the electronic devices translate and transmit the signal to each other through cables and connectors. That is to say, the connectors are the communicating bridges for the signals. The connectors are widely applied to cars and computer peripheral and communicating data applications, industries, military and aerospace industry, transportation, consumer electronics, medical treatments, instruments, commercial equipment and so on. Therefore, the connectors play an important role in many fields.

With the rapid development of industries and network information, the signal and data transmitting speed between devices is developing toward high speed. Therefore, high frequency electrical connectors have also been developed to increase transmission speed rates. Optical modules are one of the common high-frequency electrical connectors. Optical modules are optoelectronic devices for electrical-optical conversion. The transmitting end of the optical module converts electrical signals into optical signals, and the receiving end converts the optical signals into electrical signals. Optical modules can be divided into Small Form-Factor Pluggable (SFP), Gigabit Interface Converter (GBIC), Multimode Optical Transceiver (10 Gigabit Small Form Factor Pluggable, XFP), etc. The SFP optical module is a hot-inserting connector. Since SFP optical module is often plugged and unplugged, SFP optical module usually includes an unlock mechanism to increase convenience.

However, in the current technology, the number of components of the unlocking mechanism of the SFP optical module is large and complicated, thereby increasing the costs. Moreover, with the trend of miniaturization of electronic devices, the space around the connector is limited. Therefore, the user is difficult to touch the unlock components of the connector, thereby reducing the usability and convenience. In addition, the SFP optical module usually has an outer cover disposed on the outer case to protect and limit the unlock components. Although some SFP optical modules include an unlock mechanism designed with a pull-strap, the general SFP optical modules are disposed the outer cover on the outer case by the engagement between the protruding structure at the edge of the outer cover and the groove structure corresponding to the protruding structure at the bottom of the case. If the user pulls the strap with too much pulling force, the outer cover may fall off from the case under the influence of the pulling force, thereby reducing the practicability and efficiency. Furthermore, if the unlock components are lost due to the falling off of the outer cover, the unlock mechanism cannot operate, thereby increasing installation or maintenance times and reducing efficiency.

Therefore, it is necessary to provide a new connector to solve the problems of the prior art.

### SUMMARY OF THE INVENTION

Therefore, the present invention provides a stretching strap unlock connector to solve the problems with the prior art.

In one embodiment of the present invention, the stretching strap unlock connector includes a socket and a plug configured to connect the socket. The socket includes a socket case and a fixing latch. The fixing latch is configured on the socket case and has a fixing hole. The plug includes a plug case, a strap and an upper cover. The plug case has an upper surface and a sidewall and includes a fixing component, an unlock structure and a fixing groove. The fixing component and the unlock groove are configured on the upper surface, and the fixing groove is configured on the sidewall. The fixing component is configured to buckle the fixing hole of the fixing latch to connect the plug with the socket. The strap is movably configured on the upper surface of the plug case. The strap includes an unlock structure configured in the unlock groove. The upper cover is configured on the plug case and includes an engaged structure. The engaged structure is configured to buckle in the fixing groove. When the strap is pulled along the upper surface, the unlock structure is detached from the unlock groove for lifting the fixing latch of the socket case to detach the fixing component of the plug case from the fixing hole of the fixing latch, and the upper cover is engaged to the plug case through the engaged structure and not move with the strap.

Wherein, the plug case includes a moving groove configured on the upper surface, and the strap includes a protruding structure matching with the moving groove. When the strap is pulled along the upper surface, the protruding structure is configured to contact and move in the moving groove.

Wherein, the plug includes a spring, the plug case includes a blocking structure, and the strap includes a hole. The spring and the blocking structure are configured in the hole, and two ends of the spring contact the blocking structure and an inner wall of the hole respectively. When the strap is pulled along the upper surface, the spring is compressed by the inner wall to generate an elastic recovery force, and the spring pulls the unlock structure back to the unlock groove according to the elastic recovery force.

Furthermore, the upper cover is configured to cover the spring, the blocking structure and the hole.

Wherein, the unlock structure is a bendable elastic component.

Wherein, the strap includes a strap main body, and the unlock structure is hinged on the strap main body.

Wherein, the shapes of the unlock structure and the unlock groove are trapezoidal.

Wherein, the shape of the unlock structure of the upper cover is corresponding to the shape of the unlock groove of the plug case.

Wherein, the plug case has a lower surface corresponding to the upper surface and includes a bottom fixing structure configured on the lower surface, the upper cover is configured to cover the upper cover and the sidewall of the plug case. The upper cover includes a hook structure configured to engage the bottom fixing structure.

Wherein, the engaged structure is buckled in the fixing groove by riveting.

In summary, the stretching strap unlock connector of the present invention can fix the upper cover on the plug case by riveting to ensure that the upper cover will not be detached from the plug case when the user pulls the pull strap to unlock the plug, thereby improving practicability, convenience and efficiency. Moreover, the stretching strap unlock connector of the present invention can fix the upper cover on the plug case by riveting to prevent other components from falling off, thereby reducing costs and improving efficiency. Furthermore, the stretching strap unlock connector of the present invention can include various rebound mechanisms of different unlock structures, to improve efficiency and convenience. In addition, the stretching strap unlock connector of present invention can also ensure that the strap only moves in one direction through the upper cover and the moving groove, thereby reducing costs and improving efficiency.

### BRIEF DESCRIPTION OF THE APPENDED DRAWINGS

FIG. 1 is a structural schematic diagram illustrating a stretching strap unlock connector according to an embodiment of the present invention.

FIG. 2A is a structural schematic diagram illustrating the socket of the stretching strap unlock connector in one perspective view of FIG. 1.

FIG. 2B is a structural schematic diagram illustrating the plug of the stretching strap unlock connector in one perspective view of FIG. 1.

FIG. 3 is an exploded diagram illustrating the plug of the stretching strap unlock connector in FIG. 1.

FIG. 4 is an exploded diagram illustrating the plug without the upper cover in FIG. 1.

FIG. 5A is a sectional diagram illustrating the stretching strap unlock connector in connecting condition according to an embodiment of the present invention.

FIG. 5B is a sectional diagram illustrating the stretching strap unlock connector in unlocked condition in FIG. 5A.

FIG. 6 is a structural schematic diagram illustrating the strap of the stretching strap unlock connector according to an embodiment of the present invention.

FIG. 7 is an exploded diagram illustrating the plug of the stretching strap unlock connector according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of the present invention, it is to be understood that the orientations or positional relationships of the terms “longitudinal, lateral, upper, lower, front, rear, left, right, top, bottom, inner, outer” and the like are based on the orientation or positional relationship shown in the drawings. It is merely for the convenience of the description of the present invention and the description of the present invention, and is not intended to indicate or imply that the device or component referred to has a specific orientation, is constructed and operated in a specific orientation, and therefore cannot be understood as limitations of the invention.

In the description of this specification, the description with reference to the terms “a specific embodiment”, “another specific embodiment” or “parts of specific embodiments” etc. means that the specific feature, structure, material or feature described in conjunction with the embodiment include in at least one embodiment of the present invention. In this specification, the schematic representations of the above-mentioned terms do not necessarily refer to the same embodiment. Moreover, the described specific features, structures, materials or characteristics can be combined in any one or more embodiments in a suitable manner.

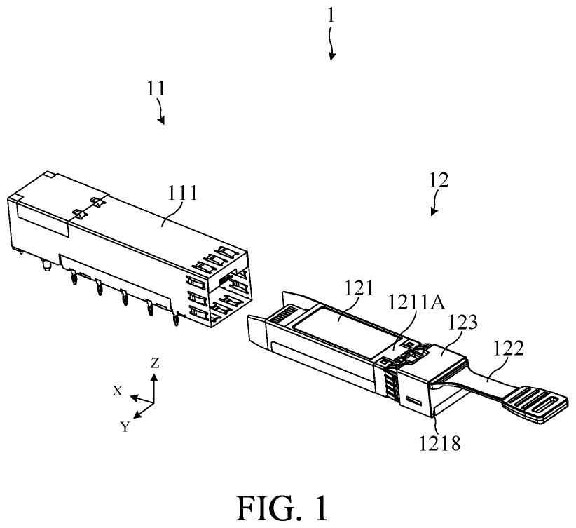

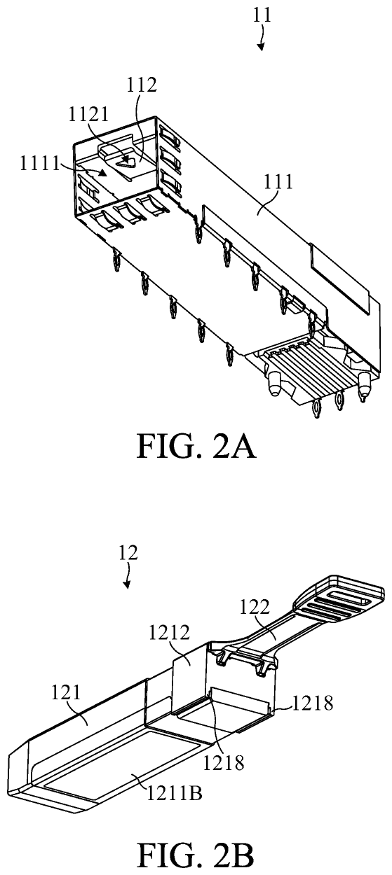

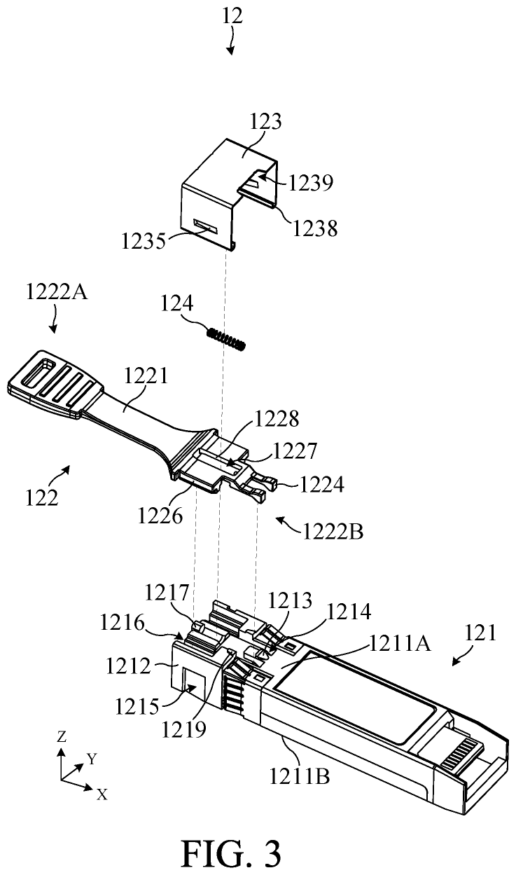

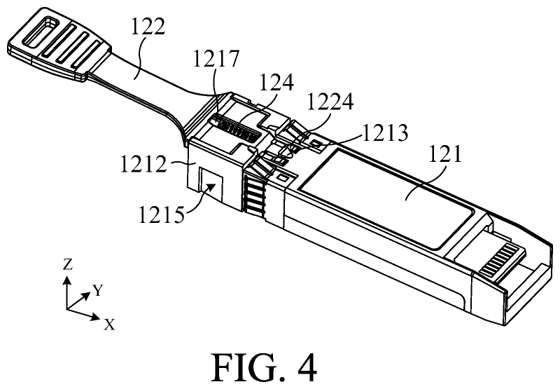

Please refer from FIG. 1 to FIG. 4. FIG. 1 is a structural schematic diagram illustrating a stretching strap unlock connector 1 according to an embodiment of the present invention. FIG. 2A is a structural schematic diagram illustrating the socket 11 of the stretching strap unlock connector 1 in one perspective view of FIG. 1. FIG. 2B is a structural schematic diagram illustrating the plug 12 of the stretching strap unlock connector 1 in one perspective view of FIG. 1. FIG. 3 is an exploded diagram illustrating the plug 12 of the stretching strap unlock connector 1 in FIG. 1. FIG. 4 is an exploded diagram illustrating the plug 12 without the upper cover 123 in FIG. 1. As shown in FIG. 1 to FIG. 4, the stretching strap unlock connector 1 of the present invention includes a socket 11 and a plug 12 connecting with each other. The socket 11 includes a socket case 111 and a fixing latch 112. The fixing latch 112 is configured on the socket case 111 and has a fixing hole 1121. The plug 12 includes a plug case 121 and a strap 122. The plug case 121 has an upper surface 1211A and includes a fixing component 1213 and an unlock groove 1214. The fixing component 1213 and the unlock groove 1214 are configured on the upper surface 1211A. The fixing component 1213 is configured to buckle the fixing hole 1121 of the fixing latch 112 to connect the plug 12 with the socket 11. The strap 122 is movably configured on the upper surface 1211A of the plug case 121. The strap 122 includes a strap main body 1221 and an unlock structure 1224. The unlock structure 1224 is disposed at one end of the strap main body 1221 and configured in the unlock groove 1214 of the plug case 121.

In practice, one end of the socket case 111 has an opening 1111, and the fixing latch 112 is configured on the socket case 111 close to the opening 1111. Furthermore, the fixing latch 112 is protruded inward from the inside wall of the socket case 111. The fixing component 1213 and the unlock groove 1214 are disposed on one end of the plug case 121, and the circuit board configured for connecting the socket 11 is disposed on the other end of the plug case 121. The fixing component 1213 is extended outward from the upper surface 1211A of the plug case 121, and the unlock groove 1214 is recessed inward from the upper surface 1211A of the plug case 121. The shape of the fixing component 1213 can be corresponding to that of the fixing hole 1121 of the fixing latch 112, and the shapes of the fixing component 1213 and the fixing hole 1121 can be design according to regulations. The strap main body 1221 has a first end 1222A and a second end 1222B, and the unlock structure 1224 is disposed on the first end 1222A of the strap main body 1221. The shape of the unlock structure 1224 can be corresponding to that of the unlock groove 1214 of the plug case 121. When the strap 122 of the plug 12 is assembled on the plug case 121, the strap 122 is disposed on the upper surface 1211A of the plug 121, and the unlock structure 1224 of the strap 122 is disposed in the unlock groove 1214 of the plug case 121. The second end 1222B of the strap 122 is extended from the end of the plug case 121. That is to say, the strap 122 and the plug case 121 are arranged in a straight line. Moreover, the strap 122 can moves along the upper surface 1211A. As shown in FIG. 1, the strap 122 can move in X-axis direction.

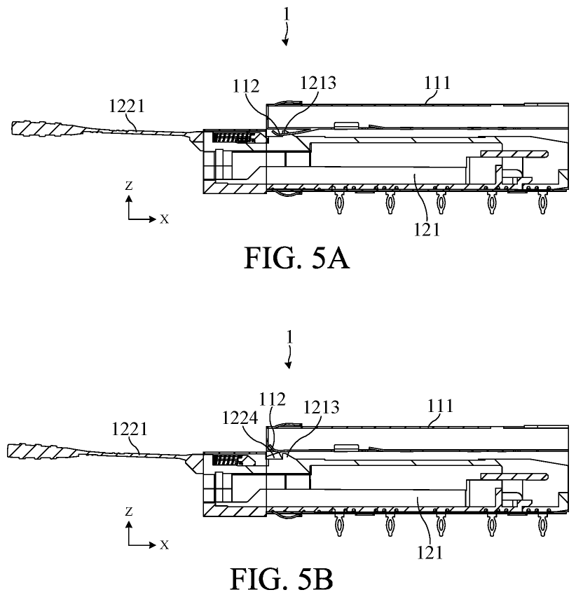

Please refer from FIG. 1 to FIG. 4, FIG. 5A and FIG. 5B. FIG. 5A is a sectional diagram illustrating the stretching strap unlock connector 1 in connecting condition according to an embodiment of the present invention. FIG. 5B is a sectional diagram illustrating the stretching strap unlock connector 1 in unlocked condition in FIG. 5A. As shown in FIG. 5A, when the plug 12 is connected to the socket 11, the user can insert the one end having the circuit board of the plug case 121 into the opening 1111 of the socket case 111. Since the fixing component 1213 of the plug case 121 is protruded outward from the upper surface 1211A and the fixing latch 112 is protruded inward from the inside wall of the socket case 111, the fixing component 1213 will contact the fixing latch 112 when the plug 12 is connected to the socket 11. At this time, the fixing latch 112 will be lifted by the fixing component 1213. In practice, the fixing component 1213 can further include a guiding structure, and the fixing component 1213 can squeeze and lift the fixing latch 112 through the guiding structure. Moreover, when the fixing component 1213 is moved to the fixing hole 1121 of the fixing latch 112, the fixing latch 112 is no longer pressed by the fixing component 1213 to return to the original position. At this time, the fixing component 1213 is engaged in the fixing hole 1121 of the fixing latch 112. In other words, the fixing latch 112 limits the fixing component 1213 to move to connect the plug 12 with the socket 11.

As shown in FIG. 5B, when the plug 12 is detached and unlocked from the socket 11, the user can stretch and pull the second end 1222B of the strap 122 in the direction away from the plug 12 (−X-axis direction). At this time, the second end 1222B of the strap 122 also drives the unlock structure 1224 located on the first end 1222A move toward the −X-axis direction. Moreover, when the unlock structure 1224 is moved in the direction away from the plug 12, the unlock structure 1224 moves along the inside wall of the unlock groove 1214. In this embodiment, the shapes of the unlock structure 1224 and the unlock groove 1214 are trapezoidal, and the unlock groove 1214 is arranged around the fixing component 1213. Therefore, when the unlock structure 1224 moves along the inside wall of the unlock groove 1214, the unlock structure 1224 will be lifted by the unlock groove 1214 to protrude from the upper surface 1211A, so that the unlock structure 1224 contacts and lifts the fixing latch 112. When the lifted height of the fixing hole 1121 of the fixing latch 112 is greater than the height of the fixing component 1213, the fixing component 1213 can be detached from the fixing hole 1121. Furthermore, after the user continuously pulls the strap 122 in −X-axis direction, the plug 12 can be detached from the socket 11. It should be noted that the shapes of the unlock structure and the unlock groove are not limited hereto. The shapes of the unlock structure and the unlock groove also can be a circle, an arc or other shapes corresponding to each other.

As shown in FIG. 1 and FIG. 3, in this embodiment, the stretching strap unlock connector 1 further includes an upper cover 123, and the upper cover 123 includes an engaged structure 1235. Moreover, the plug case 121 further includes a sidewall 1212 and a fixing groove 1215, and the fixing groove 1215 is configured on the sidewall 1212. The upper cover 123 is disposed on the plug case 121, and the engaged structure 1235 is configured to engage and buckle the fixing groove 1215 of the plug case 121. In practice, the shape of the upper cover 123 can be U shape, and the upper cover 123 can cover the upper surface 1211A and sidewall 1212 of the plug case 121. Moreover, when the plug 12 is assembled, the strap 122 is disposed on the plug case 121 first, then the upper cover 123 is disposed on the plug case 121. At this time, the first end 1222A of the strap 122 is located between the plug case 121 and the upper cover 123. That is to say, the strap 122 is not easy to separate from the plug case 121 due to the restriction. As shown in FIG. 3, the engaged structure 1235 can be an elastic sheet. The elastic sheet can be disposed along the direction of the X-axis and protrude inwardly, and the fixing groove 1215 of the plug case 121 may be recessed inwardly from the sidewall 1212 and include a contacting surface. The size of the fixing groove 1215 can be corresponding to the size of the elastic sheet. When the plug 12 is assembled, the upper cover 123 can move in X-axis direction to dispose on the plug case 121. At this time, the elastic sheet contacts the sidewall 1212 and moves outward. When the upper cover 123 continuously moves and the elastic sheet moves to the fixing groove 1215, the elastic sheet will rebound and engage into the fixing groove 1215. Furthermore, the end of the elastic sheet will contact and against the contacting surface of the fixing groove 1215, so that the upper cover 123 cannot move in X-axis or Y-axis direction. Therefore, when the user pulls the strap 122 to detach the plug 12 from the socket 11, the engaged structure 1235 can engage into the fixing groove 1215 to ensure that the upper cover 123 not be detached from the plug case 121, thereby increasing usability, convenience and efficiency. It should be noted that the number and locations of the engaged structure and the fixing groove are not limited to two in FIG. 3, the number and locations of the engaged structure and the fixing groove also can be determined as design.

As shown in FIG. 3 and FIG. 4, in this embodiment, the plug 12 further includes a spring 124, the plug case 121 further includes a blocking structure 1217, and the strap 122 further includes a hole 1227. The spring 124 and the blocking structure 1217 are disposed in the hole 1227, and two ends of the spring 124 contact the blocking structure 1217 and the inner wall 1228 of the hole respectively. When the strap 122 is pulled along the upper surface 1211A, the spring 124 is compressed by the inner wall 1228 of the hole 1227 to generate an elastic recovery force, and the spring 124 pushes the unlock structure 1224 back to the unlock groove 1214 according to the elastic recovery force. In practice, the hole 1227 can be an elongated hole and disposed the first end 1222A of the strap 122. The blocking structure 1217 can be protruded from the upper surface 1211A of the plug case 121 and disposed on the end portion of the plug case 121 close to the unlock groove 1214. The size of the spring 124 can be corresponding to the size of the hole 1227. When the strap 122 is disposed on the plug case 121, the hole 1227 of the strap 122 sleeves the blocking structure 1217 of the plug case 121, and the spring 124 is disposed in the hole 1227. The compression and extension directions of the spring 124 are the same as the moving direction of the strap 122, that is, the spring 124 can be compressed and extended along the direction of the X-axis. As shown in FIG. 4, when the user pulls the second end 1222B of the strap 122 in −X-axis direction to unlock the plug 12, the inner wall 1228 of the hole 1227 of the strap 122 pushes one end of the spring 124. Since the blocking structure 1217 of the plug case 121 contacts the other end of the spring 124, the spring 124 will be compressed due to the pushing of the inner wall 1228 of the hole 1227. Moreover, after the plug 12 is detached from the socket, the compressed spring 124 generates the elastic recovery force, and the spring 124 pushes the first end 1222A back to the original position according to the elastic recovery force to move the unlock structure 1224 to the unlock groove 1214. Therefore, the stretching strap unlock connector of the present invention can automatically move the unlocking structure back to the original position through the rebound mechanism, thereby improving efficiency and convenience.

Moreover, in this embodiment, the upper cover 123 also can cover the aforementioned spring 124, blocking structure 1217 and hole 1227. Therefore, when the plug 12 is connected or detached from the socket 11, the upper cover 123 can limit the movement of the strap 122 and the spring 124 in Z-axis direction to ensure that the strap 122 and the spring 124 only move in one direction and to prevent the spring 124 from falling off, thereby decreasing the costs and improving efficiency.

As shown in FIG. 3, in this embodiment, the plug case 121 further includes a moving groove 1216, and the strap 122 further includes a protruding structure 1226. The moving groove 1216 is disposed on the upper surface 1211A of the plug case 121, and the shape of the protruding structure 1226 is corresponding to that of the moving groove 1216. In practice, the moving groove 1216 can be disposed on the end of the plug case 121 close to the unlock groove 1214, and the disposition direction of the moving groove 1216 is the same as the moving direction of the strap 122, that is, the X-axis direction. When the strap 122 is disposed on the plug case 121, the protruding structure 1226 of the strap 122 contacts the moving groove 1216 of the plug case 121. Furthermore, when the user pulls the strap 122, the protruding structure 1226 can move in the moving groove 1216 and move in X-axis direction, to ensure that the strap 122 only moves in one direction, thereby increasing efficiency.

Moreover, as shown in FIG. 2 and FIG. 3, the plug case 121 includes a lower surface 1211B corresponding to the upper surface 1211A and a bottom fixing structure 1218, and the upper cover 123 includes a hook structure 1238. The hook structure 1238 is configured to engage the bottom fixing structure 1218, so that the upper cover 123 can be configured on the plug case 121. In practice, the hook structure 1238 can be disposed on the end of the sidewall of the upper cover 123, and the shape of the hook structure 1238 can be U shape. The bottom fixing structure 1218 can be protruded from the lower surface 1211B of the plug case 121, and the shape of the bottom fixing structure 1218 can be corresponding to the shape of the hook structure 1238. When the upper cover 123 is disposed on the plug case 121, the bottom fixing structure 1218 can be contained in the hook structure 1238 of the upper cover 123 to engage and fix the upper cover 123 on the plug case 121. Moreover, the upper cover 123 also can be disposed on the plug case 121 in sliding manner through the hook structure 1238. As shown in FIG. 3, when the upper cover 123 is disposed on the plug case 121, the hook structure 1238 of the upper cover 123 can sleeve the bottom fixing structure 1218 of the plug case 121 first, then the upper cover 123 moves in X-axis direction to dispose on the plug case 121.

In this embodiment, the plug case 121 further includes a limit block 1219 configured on the upper surface 1211A, and the upper cover 123 further includes a limit slot 1239. When the upper cover 123 is disposed on the plug case 121, the limit slot 1239 contacts and resists against the limit block 1219. In practice, when the upper cover 123 moves along X-axis direction to dispose on the plug case 121, the limit block 1219 of the plug case 121 can resist against the limit slot 1239 of the upper cover 123 to prevent the upper cover 123 from moving +X-axis direction continuously. At this time, the engaged structure 1235 of the upper cover 123 is also engaged in the fixing groove 1215 of the plug case 121 to prevent the upper cover 123 from moving −X-axis direction. Furthermore, the hook structure 1238 of the upper cover 123 is also engaged with the bottom fixing structure 1218 of the plug case 121. Therefore, the stretching strap unlock connector of the present invention can securely dispose the upper cover on the plug case through a plurality of engaging and fixing mechanisms, to prevent the strap and other components from falling off, thereby improving practicability and reducing costs.

In addition to the aforementioned embodiments, the rebound mechanism of the unlock structure of the present invention also can be other types. In one embodiment, the unlock structure can be a bendable elastic component. In practice, the unlock structure can be a plastic component. When the plug is detached from the socket, the unlock structure moves along the inside wall of the unlock groove, and the unlock groove lifts the unlock structure up to protrudes from the upper surface, so that the unlock structure lifts the fixing latch to detach the fixing component from the fixing hole. Furthermore, after the plug is detached from the socket, the unlock structure can rebound into the unlock groove according to its own elastic force, thereby improving practicability, convenience and efficiency.

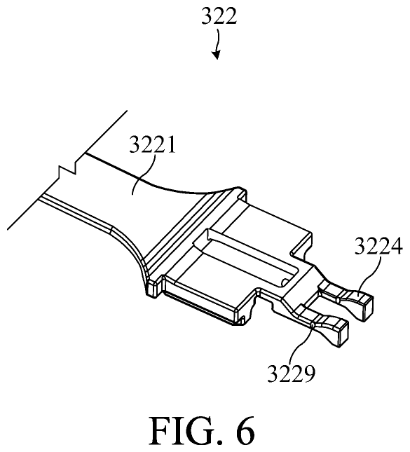

Please refer to FIG. 6. FIG. 6 is a structural schematic diagram illustrating the strap 322 of the stretching strap unlock connector 3 according to an embodiment of the present invention. As shown in FIG. 6, in this embodiment, the unlock structure 3224 is hinged on the strap main body 3221. In practice, the strap 322 further includes a hinged device 3229, and the unlock structure 3224 and the strap main body 3221 are connected to the two ends of the hinged device 3229 respectively. When the plug is detached from the socket, the unlock structure 3224 moves along the inside wall of the unlock groove, and the unlock groove lifts the unlock structure 3224 up to protrudes from the upper surface, so that the unlock structure 3224 lifts the fixing latch to detach the fixing component from the fixing hole. Furthermore, after the plug is detached from the socket, the unlock structure 3224 can rebound into the unlock groove according to its own gravity, thereby improving practicability, convenience and efficiency.

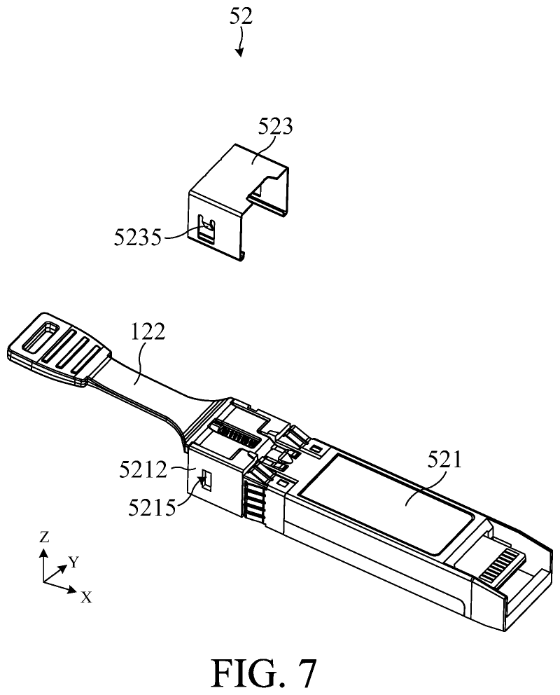

In addition to the aforementioned embodiments, the fixing manner between the upper cover and the plug case of the plug also can be other types. Please refer to FIG. 7. FIG. 7 is an exploded diagram illustrating the plug 52 of the stretching strap unlock connector 5 according to an embodiment of the present invention. In this embodiment, the engaged structure 5235 of the upper cover 523 is buckled and engaged in the fixing groove 5215 of the plug case 521 by riveting. In practice, when the plug 52 is assembled, the upper cover 523 can be disposed on the plug case 521 first, then the engaged structure 5235 is protruded inward the sidewall 5212 of the upper cover 523 by riveting, and then the protruded engaged structure 5235 is engaged and fixed in the fixing groove 5215. At this time, the upper cover 523 and the plug case 521 can regard as one component, and the upper cover 523 cannot move in X-axis or Y-axis direction. Therefore, when the user pulls the strap 522 to detach the plug 52, the engaged structure 5235 can ensure that the upper cover 523 will not detach from the plug case 521, thereby increasing practicability, convenience and efficiency.

In summary, the stretching strap unlock connector of the present invention can fix the upper cover on the plug case by riveting to ensure that the upper cover will not be detached from the plug case when the user pulls the pull strap to unlock the plug, thereby improving practicability, convenience and efficiency. Moreover, the stretching strap unlock connector of the present invention can fix the upper cover on the plug case by riveting to prevent other components from falling off, thereby reducing costs and improving efficiency. Furthermore, the stretching strap unlock connector of the present invention can include various rebound mechanisms of different unlock structures, to improve efficiency and convenience. In addition, the stretching strap unlock connector of present invention can also ensure that the strap only moves in one direction through the upper cover and the moving groove, thereby reducing costs and improving efficiency.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A stretching strap unlock connector comprising:
a socket, comprising a socket case and a fixing latch, the fixing latch being configured on the socket case and having a fixing hole; and
a plug, configured to connect to the socket, the plug further comprising:
a plug case, having an upper surface and a sidewall and comprising a fixing component, an unlock groove and a fixing groove, the fixing component and the unlock groove being configured on the upper surface, and the fixing groove being configured on the sidewall, the fixing component being configured to buckle the fixing hole of the fixing latch to connect the plug with the socket;
a strap, movably configured on the upper surface of the plug case, the strap comprising an unlock structure configured in the unlock groove; and
an upper cover, configured on the plug case and comprising an engaged structure, the engaged structure being configured to buckle in the fixing groove;
wherein, when the strap is pulled along the upper surface, the unlock structure is detached from the unlock groove for lifting the fixing latch of the socket case to detach the fixing component of the plug case from the fixing hole of the fixing latch, and the upper cover is engaged to the plug case through the engaged structure and not move with the strap.

2. The stretching strap unlock connector of claim 1, wherein the plug case comprises a moving groove configured on the upper surface, and the strap comprises a protruding structure matching with the moving groove, when the strap is pulled along the upper surface, the protruding structure is configured to contact and move in the moving groove.

3. The stretching strap unlock connector of claim 1, wherein the plug comprises a spring, the plug case comprises a blocking structure, and the strap comprises a hole, the spring and the blocking structure are configured in the hole, and two ends of the spring contact the blocking structure and an inner wall of the hole respectively, when the strap is pulled along the upper surface, the spring is compressed by the inner wall to generate an elastic recovery force, and the spring pulls the unlock structure back to the unlock groove according to the elastic recovery force.

4. The stretching strap unlock connector of claim 3, wherein the upper cover is configured to cover the spring, the blocking structure and the hole.

5. The stretching strap unlock connector of claim 1, wherein the unlock structure is a bendable elastic component.

6. The stretching strap unlock connector of claim 1, wherein the strap comprises a strap main body, and the unlock structure is hinged on the strap main body.

7. The stretching strap unlock connector of claim 1, wherein the shape of the unlock structure is corresponding to the shape of the unlock groove.

8. The stretching strap unlock connector of claim 1, wherein the shapes of the unlock structure and the unlock groove are trapezoidal.

9. The stretching strap unlock connector of claim 1, wherein the plug case has a lower surface corresponding to the upper surface and comprises a bottom fixing structure configured on the lower surface, the upper cover is configured to cover the upper cover and the sidewall of the plug case, the upper cover comprises a hook structure configured to engage the bottom fixing structure.

10. The stretching strap unlock connector of claim 1, wherein the engaged structure is buckled in the fixing groove by riveting.
